(19) United States
(12) Patent Application Publication
(10) Pub. No.: US 2026/0046879 A1
(43) Pub. Date: Feb. 12, 2026

(54) METHOD AND APPARATUS OF TIMING ADVANCE

(71) Applicant: Nokia Technologies Oy, Espoo (FI)

(72) Inventors: Matha DEGHEL, Massy (FR); Youngsoo YUK, Seoul (KR)

(21) Appl. No.: 19/101,468

(22) PCT Filed: Aug. 12, 2022
(86) PCT No.: PCT/EP2022/072657

§ 371 Date: Feb. 5, 2025

(51) Int. Cl. H04W 72/23; H04W 56/00; H04W 76/38

(52) U.S. Cl. CPC H04W 72/23; H04W 56/001; H04W 76/38

(57) ABSTRACT

Embodiments of the present disclosure relate to operation of Timing Advance. A terminal device obtains a time difference between a first downlink reference signal and a second downlink reference signal. The terminal device also transmits an indication on status of the time difference relative to a threshold. The solution for operation of Timing Advance as provided in the present disclosure can allow switching between multiple TAs and can achieve network energy savings.

### FIELD

Embodiments of the present disclosure generally relate to the field of telecommunication and in particular, to a terminal device, a network device, network devices, methods, apparatuses and a non-transitory computer readable storage medium of timing advance.

### BACKGROUND

In New Radio (NR) systems, the concept and functionality of NR timing advance (TA) is substantially same as the long term evolution (LTE) timing advance. Briefly, TA is a special command (e.g. notification) from a network device to a terminal device that enables the terminal device to adjust its uplink transmission. This kind of uplink adjustment may apply to Physical Uplink Shared Chanel (PUSCH), Physical Uplink Control Chanel (PUCCH), SRS and etc.

In 3GPP release 18, it was agreed to support two-TA enhancement for uplink (UL) multi-downlink control information (DCI) for multi-Transmission and reception point (TRP) operation. However, solutions regarding multiple TAs need to be further studied.

### SUMMARY

In general, example embodiments of the present disclosure provide a solution for operation of Timing Advance.

In a first aspect, there is provided a terminal device. The terminal device may comprise at least one transceivers; and one or more processors communicatively coupled to the one or more transceivers, and the one or more processors are configured to cause the terminal device to: obtain, by the terminal device, a time difference between a first downlink reference signal and a second downlink reference signal; and transmit, by the terminal device, an indication on status of the time difference relative to a threshold.

In a second aspect, there is provided a network device. The network device may comprise one or more transceivers; and one or more processors communicatively coupled to the one or more transceivers, and the one or more processors are configured to cause the network device to: receive, by the network device, an indication on status of a time difference between a first downlink reference signal and a second downlink reference signal relative to a threshold; and transmit, by the network device, a configuration to activate or deactivate using of a timing advance, TA.

In a third aspect, there is provided a method implemented at a terminal device. The method may comprise obtaining, by the terminal device, a time difference between a first downlink reference signal and a second downlink reference signal; and transmitting, by the terminal device, an indication on status of the time difference relative to a threshold.

In a fourth aspect, there is provided a method implemented at a network device. The method may comprise receiving, by the network device, an indication on status of a time difference between a first downlink reference signal and a second downlink reference signal relative to a threshold; and transmitting, by the network device, a configuration to activate or deactivate using of a timing advance, TA.

In a fifth aspect, there is provided an apparatus of terminal device comprising means for obtaining a time difference between a first downlink reference signal and a second downlink reference signal; and means for transmitting an indication on status of the time difference relative to a threshold.

In a sixth aspect, there is provided an apparatus of network device comprising means for receiving an indication on status of a time difference between a first downlink reference signal and a second downlink reference signal relative to a threshold; and means for transmitting a configuration to activate or deactivate using of a timing advance, TA.

In an seventh aspect, there is provided a terminal device. The terminal device comprises at least one processor and at least one memory including computer program codes, wherein the at least one memory and the computer program codes are configured to, with the at least one processor, cause the terminal device to perform the method in the third aspect.

In an eighth aspect, there is provided a network device. The network device comprises at least one processor and at least one memory including computer program codes, wherein the at least one memory and the computer program codes are configured to, with the at least one processor, cause the network device to perform the method in the fourth aspect.

In a ninth aspect, there is provided a non-transitory computer readable medium comprising program instructions for causing an apparatus to perform at least the method according to any one of the above third to fourth aspect.

In a tenth aspect, there is provided a computer program comprising instructions, which, when executed by an apparatus, cause the apparatus at least to: obtain a time difference between a first downlink reference signal and a second downlink reference signal; and transmit an indication on status of the time difference relative to a threshold.

In an eleventh aspect, there is provided a computer program comprising instructions, which, when executed by an apparatus, cause the apparatus at least to: receive an indication on status of a time difference between a first downlink reference signal and a second downlink reference signal relative to a threshold; and transmit a configuration to activate or deactivate using of a timing advance, TA.

In a twelfth aspect, there is provided a terminal device. The terminal device may comprise: obtaining circuitry configured to obtain a time difference between a first downlink reference signal and a second downlink reference signal; and transmitting circuitry configured to transmit an indication on status of the time difference relative to a threshold.

In a thirteenth aspect, there is provided a network device. The second device may comprise: receiving circuitry configured to receive an indication on status of a time difference between a first downlink reference signal and a second downlink reference signal relative to a threshold; and transmitting circuitry configured to transmit a configuration to activate or deactivate using of a timing advance, TA.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates an example flowchart of a method 200 of operation of TAs at terminal device according to some embodiments of the present disclosure;

FIG. 3 illustrates an example flowchart of a method 300 of another operation of TAs at terminal device according to some embodiments of the present disclosure;

FIG. 4 illustrates an example flowchart of a method 400 of operation of TAs at network device according to some embodiments of the present disclosure;

FIG. 5 illustrates an example flowchart of a method 500 of another operation of TAs at network device according to some embodiments of the present disclosure;

FIG. 6 illustrates an example process 600 for operation of TAs according to some embodiments of the present disclosure;

FIG. 7 illustrates an example process 700 for another operation of TAs according to some embodiments of the present disclosure;

FIG. 8 illustrates an example simplified block diagram of a device that is suitable for implementing embodiments of the present disclosure; and

FIG. 9 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element may be termed a second element, and similarly, a second element may be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, the future sixth generation (6G) and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to abase station (BS) or an access point (AP) or a transmission and reception point (TRP), for example, a node B (NodeB or NB), an evolved NodeB (eNodeB or eNB), a NR NB (also referred to as a gNB), a remote radio unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

As used herein, the term “TRP” refers to a transmit-receive point having an antenna array (with one or more antenna elements) at the network side located at a specific geographical location, which may be used for transmitting and receiving signals to/from the terminal device. In embodiment of the present disclosure, a TRP may refer to Macro Cell, micro cell, an RRH, a relay, a femto node, a pico node, etc. Although some embodiments of the present disclosure are described with reference to two TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As discussed above, TA is a special command (e.g. notification) from eNB to a terminal device that enables the terminal device to adjust its uplink transmission. TA is a special command (e.g. notification) from a network device to a terminal device that enables the terminal device to adjust its uplink transmission.

TA can be delivered to a terminal device through random access response (RAR) or MAC CE (medium access control control element). A TA loop can be used to maintain the TA to enable alignment of UL signals (transmitted from a terminal device) at a network node within a certain time resolution. For example, in a random access procedure, the terminal device may receive an initial TA value (e.g., an absolute TA value) in a RAR message. The TA value may then be updated with a MAC CE containing a timing advance command (TAC) indicating e.g. a relative TA value. In addition, the UE may also autonomously update the TA by initiatively request an updated TA value. The operations of maintain the TA may be called as a TA loop. Usually, a TA loop may correspond to UL transmissions toward for example a given TRP. In addition, a TA loop may correspond to TA maintained within a TAG. Therefore, one TA loop may correspond to one TA and the number of TA loops may indicate the number of used TAs. Thus, in the present disclosure, a TA loop may refer to a TA implicitly.

A timing advance group (TAG) used herein means a group consists of one or more serving cells with the same uplink TA and same downlink timing reference cell. Each TAG contains at least one serving cell with configured uplink, and the mapping of each serving cell to a TAG is configured by a radio resource control (RRC) signal. In 3GPP release 18, it was already agreed to support, in NR system, two TAs for UL multi-DCI for multi-TRP operation. In addition, the support of two TA enhancement has been agreed for both intra-cell and inter-cell multi-DCI multi-TRP scenarios in 3GPP release 18.

The inventors notice that one of important aspects to consider is that operating with two TA loops may not be needed all the time, e.g. probably depending on the terminal device location with respect to two TRPs, in case of dynamic TRP unmuting/muting for achieving network energy savings), etc. In other words, in some conditions, two TAs are not needed for a terminal device. instead, a single TA loop may be sufficient

Thus, it is required to provide specific ways, conditions and methods to enable the network to decide whether to operate a terminal device with two (or more) TAs or just a single TA at a given situation. Also, a new solution is also required to allow juggling between one TA loop or two (or more) TA loops based on different situations.

According to embodiments of the present disclosure, there is provided a solution for operation of TAs. In this solution, a time difference between a first downlink reference signal and a second downlink reference signal are obtained, and an indication on status of the time difference relative to a threshold will be transmitted to the network by a terminal device. By this solution, it is possible to realize multi-TA operation for multi-TRP cases, as well as dynamic TA mode adaption. Therefore, network system efficiency may be improved correspondingly.

Although functionalities described herein can be performed, in various example embodiments, in a fixed and/or a wireless network node may, in other example embodiments, functionalities may be implemented in user equipment (such as a cell phone or tablet computer or laptop computer or desktop computer or mobile IOT device or fixed IOT device). This user equipment may, for example, be furnished with corresponding capabilities as described in connection with the fixed and/or the wireless network node(s), as appropriate. The user equipment may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

Principle and embodiments of the present disclosure will be described in detail below with reference to the accompanying drawings. However, it is to be noted that these embodiments are given to enable the skilled in the art to implement the solution as proposed herein and not intended to limit scope of the present application in any way.

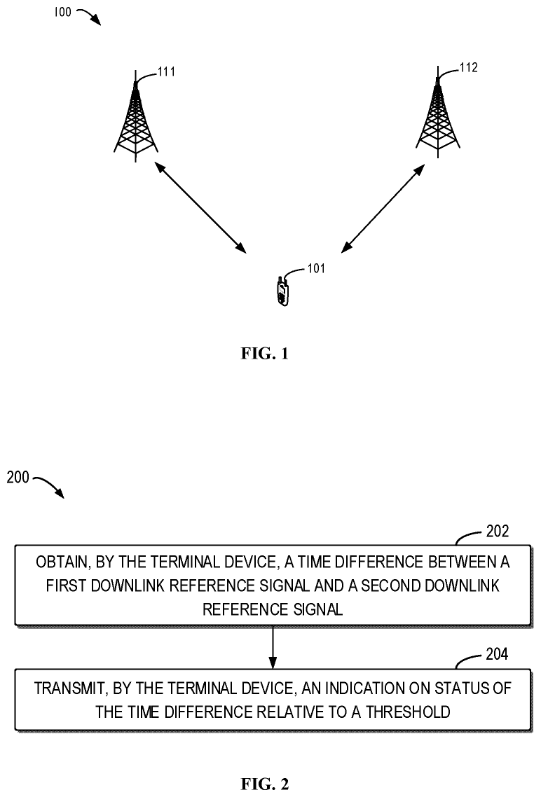

Reference is first made to FIG. 1, which illustrates an example communication system 100 in which embodiments of the present disclosure may be implemented. As illustrated in FIG. 1, the system 100 includes two network devices, such as TRP 111 and 112. For clarity, TRP 111 is also referred to a first TRP and TRP 112 is referred to a second TRP. The network devices 111 and 112 may have one respective group of antenna ports. So the network devices 111 and 112 may be associated with or function as two respective TRPs, and thus can be also called as TRP 111 and TRP 112 in the present disclosure. The TRP 111 and 112 may send their respective reference signals. That is, TRP 111 is corresponding to its reference signal (referred as a first resentence signal for clarity), and TRP 112 is corresponding to its reference signal (referred as a second resentence signal for clarity).

The system 100 also includes terminal devices, such as a terminal device 101. The terminal device 101 is capable of communicating with the TRP 111 and 112. The terminal device 101 may receive uplink reference signals (DL RSs) from the two TRPs. The terminal device 101 may determine, obtain or measure a time difference (or propagation delay difference) between two DL RSs, or based on two DL RSs or CORESETPoolIndex(es). It is appreciated that two DL RSs may transmitted from two TRP respectively.

In the solution of present disclosure, the terminal device 101 may transmit an indication that indicates a status of the time difference and a threshold. The network device may determine a configuration regarding TA based on the status and send the configuration to the terminal device 101. The configuration may indicate the terminal device 101 to activate an operation of further using a second TA associated with the second TRP, or deactivate one or more TA, depending on the status of the time difference. Thus, the TA loops corresponding to the TRP 111 and 112 can be activated or deactivated based on the indication.

In communication systems, “UL” refers to a communication link in a direction from a terminal device to a network device, and “DL” refers to a communication link in a direction from the network device to the terminal device.

It is to be understood that in FIG. 1, the number of network devices (TRPs) and terminal devices is only for the purpose of illustration without suggesting any limitations. The system 100 may include any suitable number of network devices (TRPs) and terminal devices adapted for implementing embodiments of the present disclosure.

Communications in the communication system 100 may be implemented according to any proper communication protocol(s), comprising, but not limited to, cellular communication protocols of the third generation (3G), the fourth generation (4G) and the fifth generation (5G) or beyond, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Reference is made to FIG. 2, which illustrates a method 200 of operation of TAs at terminal device. In this method, a solution is provided to juggle between one TA or two at by a terminal device. Hereinafter, sometimes, reference might be made to two TAs to describe the solution as proposed herein, but it is to be noted that it is only an example scenario and the present disclosure is not limited thereto; instead, the solution could be also applied in to a scenario of more than two TAs.

At block 202, a time difference between a first downlink reference signal and a second downlink reference signal is obtained. For example, the terminal device 101 may obtains the time difference between a first downlink reference signal and a second downlink reference signal, for example, by measuring the first downlink reference signal and the second downlink reference signal.

In some example embodiments, the network may configure or indicate the terminal device, via RRC, MAC CE and/or DCI (using new or existing/reserved bits or fields), the two DL RSs to be used by the terminal device for measuring the time difference. As an example, the at least two DL RSs may be at least two tracking reference signals (TRSs), each of which is configured per TRP (or CORESETPoolIndex or PCI). The two TRSs may be periodic. As another example, measurement may be made for beams (SSB or CSI-RS) from two TRPs.

In some example embodiments, the first downlink reference signal may be corresponding to a first TRP and the second downlink reference signal may be corresponding to a second TRP. For example, the first downlink reference signal may be corresponding to the TRP 111, and the second downlink reference signal may be corresponding to the TRP 112.

In some example embodiments, the indication may be triggered based on the time difference and a threshold, when the terminal is operating with a single TA. In some example embodiments, the indication may be triggered based on the time difference and another threshold, when the terminal is operating with more than one TA. The two thresholds may have a same value. In other word, the two trigger conditions share the trigger threshold, or the first threshold and the second threshold can be the same one. Preferably, the two thresholds may have different set values. For example, the first threshold for the signal TA is larger than the second threshold e.g. for more than one TA.

In some example embodiments, the indication may be triggered when the time difference is higher than or equal to or is not lower than a threshold, for example, when the terminal is operating with a single TA. It is appreciated that alternatively, the indication may also be triggered based on whether the time difference is strictly higher than the threshold; in other words, the time difference equal to the threshold will not trigger the indication.

In some example embodiments, the terminal device may be operating using a first TA corresponding to a first TRP and a second TA corresponding to a second TRP, and the indication may indicate a status regarding the time difference being lower than the threshold or a status regarding the time difference being lower than or equal to or not higher than the threshold.

In some example embodiments, the indication may be triggered when a number of times that the time difference being higher than or equal to or not lower than the threshold is beyond a predetermined number, for example, when the terminal is operating with a single TA. As an example, the indication may be sent if the number or counts of instances when the time difference is higher than or equal to or not lower than the threshold reaches a preconfigured number. It is appreciated that alternatively, the indication may also be triggered based on whether the number or the counts is strictly higher than the preconfigured number; in other words, the number or the count equal to the preconfigured number will not trigger the indication.

In some example embodiments, the indication may be triggered when a duration of the time difference being higher than or equal to or not lower than the threshold is beyond a predetermined duration, for example, when the terminal is operating with a single TA. As an example, the predetermined duration and the threshold may be received from the network. The terminal device 101 compares the duration of the time difference being higher than or equal to or not lower than the threshold and the predetermined duration. Upon determining that the duration is beyond the predetermined duration, the indication will be triggered.

In some example embodiments, the terminal device may be operating using a first TA corresponding to a first TRP and a second TA corresponding to a second TRP, and the indication may indicate a status regarding the time difference being lower than the threshold or a status regarding the time difference being lower than or equal to or not higher than the threshold.

In some example embodiments, the indication may be triggered when the time difference is lower than a threshold for example, when the terminal is operating with more than one TA. It is appreciated that alternatively, the indication may also be triggered based on whether the time difference is strictly lower than the threshold; in other words, the time difference equal to the threshold will not trigger the indication.

In some example embodiments, the indication may be triggered when a number of times that the time difference being lower than the threshold is beyond a predetermined number, for example, when the terminal is operating with more than one TA. As an example, the indication may be sent if the number or counts of instances when the time difference is lower than or equal to the threshold reaches a preconfigured number. It is appreciated that it is also applicable for the case if the number or the counts being strictly lower than the preconfigured number is used as a trigger condition; in other words, the number or the count equal to the preconfigured number will not trigger the indication.

In some example embodiments, the indication may be triggered when a duration of the time difference being lower than the threshold is beyond a predetermined duration, for example, when the terminal is operating with a more than one TA. As an example, the predetermined duration and the threshold may be received from the network. The terminal device 101 compares the duration of the time difference being lower than or equal to or not higher than the threshold and the predetermined duration. Upon determining that the duration is beyond the predetermined duration, the indication will be triggered.

In some example embodiments, both intra-cell multi-TRP and inter-cell multi-TRP may be configured, and obtaining the time difference may comprise obtaining a time difference for the intra-cell multi-TRP and one or more time differences for the inter-cell multi-TRP.

As an example, for inter-cell multi-TRP cases, the above proposed operations of TAs may also be applied where one of the TRPs is in a cell with a PCI different than serving cell PCI. Additionally, or alternatively, in case of both intra-cell and inter-cell multi-TRP, the terminal device may measure two (or more) time differences, e.g., one for intra-cell multi-TRP and one (or more) for inter-cell multi-TRP. The terminal device 101 may send indications corresponding to those time differences as proposed above. It is noted that a primary TRP may be defined in this case, where the time difference corresponding to another TRP(s) may be measured with respect to the primary TRP.

As an example, if the terminal device is required to measure two or more time differences, corresponding to different DL RSs or beams (SSB or CSI-RS) from two TRPs (or corresponding to more than two TRPs, etc.), the terminal device may be configured to send the above proposed indication or report corresponding to only the minimum or maximum among measured time differences.

At block 204, an indication on status of the time difference relative to a threshold is transmitted by the terminal device to the network device. For example, the terminal device 101 transmits an indication on status of the time difference relative to a threshold.

In some example embodiments, the indication may be carried in Uplink Control Information, UCI, or Medium Access Control Control Element, MAC CE. In some embodiments, the status of the time difference relative to a threshold may include any of:
the time difference being higher than or equal to or not lower than a threshold,
the time difference being higher than a threshold,
the time difference being lower than or equal to or not higher than a threshold,
the time difference being lower than a threshold,
a number of times that the time difference being higher than or equal to or not lower than the threshold is beyond a predetermined number;
a number of times that the time difference being higher than the threshold is beyond a predetermined number;
a duration of the time difference being higher than or equal to or not lower than the threshold is beyond a predetermined duration;
a duration of the time difference being higher than the threshold is beyond a predetermined duration;
a duration of the time difference being lower than the threshold is beyond a predetermined duration;
a duration of the time difference being lower than or equal to or not higher than the threshold is beyond a predetermined duration;
a number of times that the time difference being lower than the threshold is beyond a predetermined number; or
a number of times that the time difference being lower than or equal to or not higher than the threshold is beyond a predetermined number.

In some example embodiments, such an indication can be carried in, for example, UCI or any other suitable uplink message.

In some example embodiments, it may use a bit on dedicated or shared PUCCH resources (such as format 0/1) to carry the indication. For example, the indication is set as a predetermined value (value “0” or “1”) to indicate a first status concerning the time difference being higher than a threshold (e.g., any of status relating to “higher than”), or a second status concerning the time difference being lower than a threshold (e.g., any of status relating to “lower than”). In other words, the indication itself just informs of the network device the trigger of indication, without indicating how the indication is triggered, for example since the time difference is higher than or equal to a threshold, or since the time difference is lower than a threshold. However, the network device could learn the TA mode at the terminal device, it could know the actual meaning of the indication based on the TA mode the terminal device is currently using. For example, when the terminal device is operating with a single TA, it means the first status concerning the time difference being higher than or equal to or not lower than a threshold; when the terminal device is operating with more than one TA, it means the second status concerning the time difference being for example lower than a threshold.

In some embodiments, where a first value (e.g., 1 or 0) of the bit may indicate a first status concerning the time difference being for example higher than a threshold (e.g., any of status relating to “higher than”), and a second value (different from the first value, e.g., value ‘0’ or “1”) of the bit may indicate the second status concerning the time difference being lower than a threshold (e.g., any of status relating to “lower than”). In other word, the value of the bit could directly indicate different status of the time difference. In such a case, the network device could learn the reported status of the time difference directly from the indication, without other information.

In some example embodiments, the network device may (at least optionally) use the above proposed indication/report to decide whether, for the terminal device, one or two TA loops (or TAGs) should be active e.g. in a serving cell configured with multi-TRP. Alternatively, whether in addition to an active primary TA loop (e.g. the one corresponding to CORESETPoolIndex 0), a secondary TA loop should be activated e.g. in a serving cell or even non-serving cell (i.e., cell with a PCI different than the serving cell PCI).

In some example embodiments, the terminal device may be further caused to: receive, by the terminal device, a configuration indicating the terminal device to activate an operation of further using a second TA associated with the second TRP, or indicating deactivate one of the first TA and the second TA corresponding to the first TRP and the second TRP. For example, the terminal device 101 receives a configuration indicating the terminal device to activate an operation of further using a second TA associated with the second TRP. For example, when the first status is reported, the network device may determine to switch from the one TA mode to two-TA mode and transmit to the terminal device so that the terminal device activates an operation of further using a second TA associated with the second TRP. On the other hand, if the second status is reported, the network may determine to use only one TA for both the first and second TRPs, and then transmit an indication to the terminal device to deactivate one of first TA and the second TA sot that the other TA is used for both the first TRP and the second TRP.

In some example embodiments, TA may be maintained through TA loop. For example, TA can be delivered to terminal device through RAR or MAC CE. In the case that it is delivered through RAR, the terminal device figures out the TA value from two different MAC layer commands depending on situation. For the first Uplink message after physical random access channel (PRACH), terminal device applies the TA value that it extracts from RAR (RACH response). After the initial RACH process, the terminal device would apply the TA value that it extracts from TA MAC CE if it received it.

In some example embodiments, in the case that it is delivered through MAC CE, as mentioned above, the terminal device adjust UL transmission timing based on RAR during the RACH procedure. Once the initial attach is complete, the terminal device adjusts UL transmission based on the MAC CE Timing Advance.

In some example embodiments, the terminal device may be further caused to: receive, by the terminal device, a configuration indicating the terminal device to deactivate an operation of using the first TA or the second TA, or indicating the first TA or the second TA is used for both the first TRP and the second TRP.

In some example embodiments, the network device may indicate the UE, via MAC CE and/or DCI (using new or existing/reserved bits or fields) and/or RRC (or even via a broadcast message), to activate or deactivate/stop maintaining at least one TA loop (corresponding to at least one TAG or TRP) in at least one serving cell or even non-serving cell (i.e., cell with a PCI different than serving cell PCI). In other word, the configuration may be carried by Downlink Control Information, DCI, MAC CE, Radio Resource Control, or RRC, signaling.

In some example embodiments, deactivating the operation of using the first TA or the second TA may comprise stopping maintaining the first TA or the second TA.

In some example embodiments, the first TA may be associated with a first TA Group, TAG, or associated with the first TRP corresponding to the first TAG. In some example embodiments, the second TA may be associated with a second TAG, or associated with the second TRP corresponding to the second TAG.

The meaning of TAG can be considered as follows: a group of Serving Cells that is configured by RRC and that, for the cells with a UL configured, using the same timing reference cell and the same Timing Advance value. A Timing Advance Group containing the SpCell of a MAC entity is referred to as Primary Timing Advance Group (PTAG), whereas the term Secondary Timing Advance Group (STAG) refers to other TAGs. Thus, it is appreciated that a TAG consists of one or more serving cells with the same uplink TA and same downlink timing reference cell. Each TAG contains at least one serving cell with configured uplink, and the mapping of each serving cell to a TAG is configured by RRC.

In some example embodiments, the terminal device may be further caused to: receive, by the terminal device, a threshold configuration, wherein the threshold configuration comprises one or more threshold. As mentioned hereinabove, it is possible to configure one single threshold for the terminal device or two different thresholds for different situations.

As an example, on the indication from the network to the terminal device 101 to activate/deactivate at least one TA loop corresponding to a TRP/TAG. This indication can be carried through the DCI carried in the PDCCH of the RAR (random access response). Alternatively, this indication may be carried through MAC CE carried in the PDSCH of the RAR.

In some example embodiments, a TRP which the configuration is for may be determined based on the control resource set, CORESET in which the configuration is transmitted. As an example, the terminal device 101 may determine which TRP the indication is for through the CORESET used to send the PDCCH carrying the DCI including the indication. For example, if this CORESET belongs to CORESETPoolIndex 0, the terminal device 101 would know that the indication of activation or deactivation is for the TA loop corresponding to TRP 111 or the TA loop corresponding to a TAG associated with TRP 111.

The terminal device may receive configuration of multi-TA (e.g., two TAGs in a serving cell) for multi-TRP scenario (e.g., at least two CORESETPoolIndex configured). In addition, the terminal device may be configured or indicated (e.g., via RRC, MAC CE, or DCI (such as UE dedicated DCI and group-common DCI), including MAC CE/DCI corresponding to RAR, or via broadcast message) whether, e.g. immediately after RRC configuration or reconfiguration, to consider both TA loops as active or only one TA loop as active, and if so, which one. For example, the terminal device may be configured or specified to start with only one TA loop as active, such as the TA loop corresponding to CORESETPoolIndex 0 or corresponding to the TRP (or CORESETPoolIndex) on which the initial access or corresponding random-access procedure was made or performed. Then the proposed method 200 regarding the reporting of the indication that the time difference is higher than a threshold and/or the indication of activating/deactivating of a TA loop may be used.

In some example embodiments, both intra-cell multi-TRP and inter-cell multi-TRP may be configured, and the terminal device may be further caused to: report, by the terminal device, a capability of the terminal device supporting a number of TAs. As an example, considering the scenario where both intra-cell multi-TRP and inter-cell multi-TRP are configured, the terminal device may have e.g. three serving TRPs where two are in the serving cell and one in the non-serving cell (i.e., the cell with a PCI different than the serving cell PCI). In this case, the terminal device may report capability of supporting maximum two TA loops at a time. Alternatively, the terminal device may report capability of supporting maximum three (or more) TA loops at a time, and this may mean at least maintaining three (or more) TA loops.

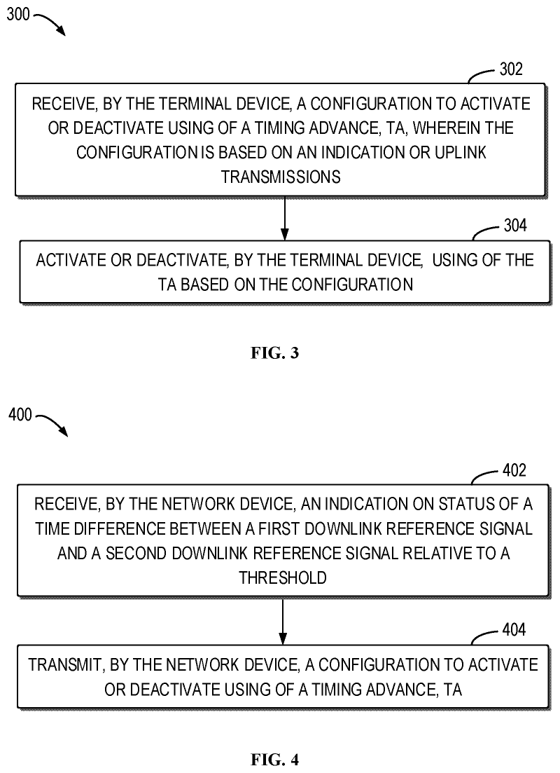

Reference is made to FIG. 3, which illustrates a flowchart of method 300 of another operation of TAs at terminal device according to some embodiments of the present disclosure. The method 300 can be implemented in combination with those operations as described with reference to the method 200, or can be implemented independent.

As illustrated, at block 302, a configuration is received by a terminal to activate or deactivate using of a Timing Advance, TA, wherein the configuration is based on an indication or uplink transmissions. As an example, the decision on activation/deactivation of TA loop(s) may be made by the network based on UL transmissions such as PRACH transmissions. In this case, the terminal device may not be configured to measure the time difference and report event related to this measurement. Or alternatively, the decision may also rely on the indication reported by the terminal device as described with reference to FIG. 2.

At block 304, using of the TA is activated or deactivated by the terminal device based on the configuration. As an example, if the configuration indicates the terminal device to activate using of the second TA, the terminal device 101 will activate the using of the second TA.

For a purpose of simplification, similar operations to those in FIG. 2 are not elaborated, For details about other similar concepts or operations, reference may be made to corresponding description with regard to FIG. 2.

Thus, by means of such of proposed solution as proposed herein, it is possible to allow switching of TA operation between one TA loop or two (or more) TA loops, thus improving network performance.

Reference is made to FIG. 4, which illustrates a flowchart of a method 400 of operation of TAs at network device according to some embodiments of the present disclosure.

At block 402, an indication is received by the network device, wherein the indication indicate status of a time difference between a first downlink reference signal and a second downlink reference signal relative to a threshold. As an example, the network device 111 and/or 112 may receive an indication on status of a time difference between a first downlink reference signal and a second downlink reference signal relative to a threshold.

In some embodiments, the first downlink reference signal may be corresponding to a first TRP, and the second downlink reference signal may be corresponding to a second TRP. For example, the first downlink reference signal may be corresponding to the TRP 111, and the second downlink reference signal may be corresponding to the TRP 112.

In some example embodiments, the indication may indicate a status regarding the time difference being higher than or equal to or not lower than the threshold, or a status regarding the time difference being higher than the threshold. As an example, the indication can be carried as UCI. For instance, using dedicated or shared PUCCH resources (such as format 0/1).

In some example embodiments, the indication may indicate a status regarding the time difference being lower than the threshold, or a status regarding the time difference being lower than or equal to or not higher than the threshold. Likewise, using dedicated or shared PUCCH resources (such as format 0/1).

In some example embodiments, the indication may be carried in uplink control information, UCI, or medium access control control element, MAC CE. In some example embodiments, the configuration may be carried by downlink control information, DCI, MAC CE, or radio resource control, RRC, signaling.

In some example embodiments, a configuration for a TRP may be transmitted on a control resource set, CORESET corresponding to the TRP, so that the TRP which the configuration is for can be determined based on the Control Resource Set, CORESET.

In some example embodiments, both intra-cell multi-TRP and inter-cell multi-TRP may be configured, the network device may be further caused to: receive, by the network device, a report of a capability of a terminal device supporting a number of TAs. For example, TRP 111 or 112 may receive report of a capability of a terminal device supporting a number of TAs.

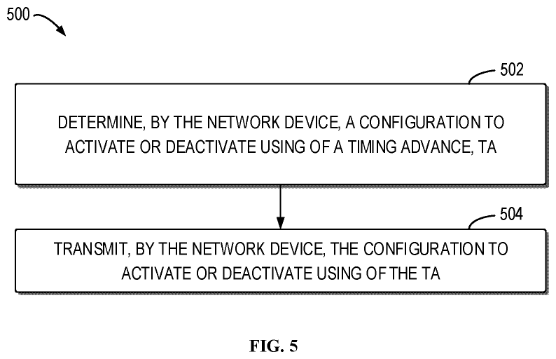

Reference is further made to FIG. 5, which illustrates a flowchart of another method 500 of another operation of TAs at network device according to some embodiments of the present disclosure. The method 500 can be implemented with the method 400, or can be implemented individually.

At block 502, the network device determines a configuration is determined, based on an indication from the terminal device or uplink transmissions, wherein the configuration is to activate or deactivate using of a timing advance, TA. As an example, the decision on activation/deactivation of TA loop(s) may be made by the network based on UL transmissions such as PRACH transmissions, or based on UE location/position with respect to the TRPs, or even based on whether single-TRP or multi-TRP operation is more suitable for a given period of time. As another example, the decision on activation/deactivation of TA loop(s) may be made by the network in accordance with reported indication based on this measurement.

At block 504, the network device transmits the configuration to activate or deactivate using of the TA. For example, in responsive to a determination that the configuration is to activate using the TA, the network device 111 and/or 112 transmit the configuration to activate using of the TA to the terminal device 101. Or alternatively, the network device 111 and/or 112 may transmit the configuration to deactivate using of a TA to the terminal device 101.

It is appreciated that the method 400 is corresponding to the method 200, and method 500 is corresponding to the method 300. The similar parts of the technical features are described with reference to FIG. 2, FIG. 3 and their corresponding descriptions. For a purpose of simplification, similar operations to those in the terminal device are not elaborated.

Therefore, by means of such of proposed methods 400 or 500, it is also possible to allow juggling between one TA loop or two (or more) TA loops being active a time, thus improving network performance.

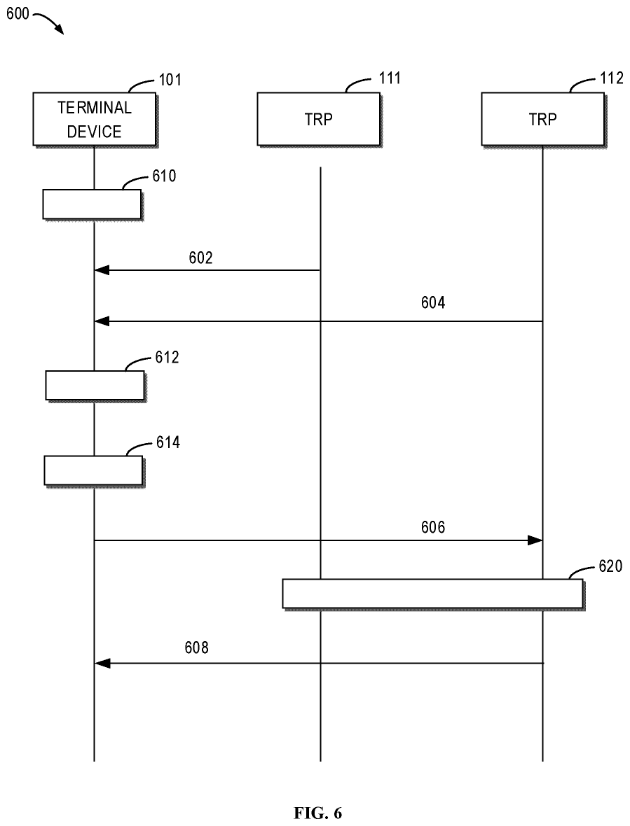

Reference is now made to FIG. 6, which shows a process 600 for operation of TAs according to an embodiment of the present disclosure. For the purpose of discussion, the process 600 will be described with reference to FIG. 1. The process 600 may involve the terminal device 101 and the TRP 111 and 112 as illustrated in FIG. 1. It would be appreciated that although the process 600 has been described in the communication system 100 of FIG. 1, this process may be likewise applied to other communication scenarios where different network devices are jointly deployed to provide respective serving cells. It would also be appreciated that although the operation of TAs between the terminal device 101 and the TRP 111 and 112 is discussed, a similar process can be applied for any other terminal devices or network devices.

In the process 600, the terminal device 101 is operating using a first TA corresponding to the TRP 111. The terminal device 101 obtains 610 a threshold configured by the network device. Additionally, the terminal device 101 may also obtain a report of a capability of the terminal device 101 supporting a number of TAs to the network. This report may be received via a message separate from the threshold configuration. The terminal device 101 receives 602 a first downlink reference signal which is corresponding to TRP 111. The terminal device 101 receives 604 a second downlink reference signal which is corresponding to the TRP 112. The terminal devices 101 measures the time difference between the first downlink reference signal and the second downlink reference signal and determines 612 a status of a time difference relative to a threshold. In responsive to a determination that the time difference is higher than or equal to or not lower than a threshold, or a number of times that the time difference being higher than or equal to or not lower than the threshold is beyond a predetermined number, or a duration of the time difference being higher than or equal to or not lower than the threshold is beyond a predetermined duration, the terminal device 101 triggers 614 an indication that indicates such status. The terminal device 101 than transmits 606 the indication to the TRP 112. Based on the indication, the network decides 620 to activate the second TA corresponding to the TRP 112. The TPR 112 transmits 608 a configuration indicating the terminal device 101 to activate an operation of further using the second TA corresponding to the TRP 112.

It is noted that although FIG. 6 mentions about association of a TA loop to a TRP, this association may be indirect. For example, the TA loop may only be associated to a TAG and not to a TRP. For another example, a TA loop corresponds to a TAG and this TAG is associated to a TRP or CORESETPoolIndex (or PCI).

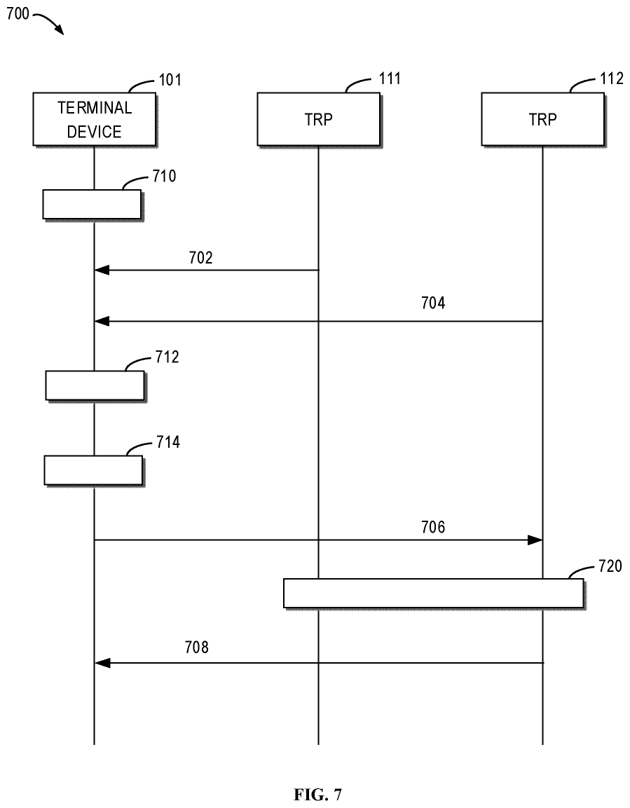

Reference is now made to FIG. 7, which shows a process 700 for another operation of TAs according to an embodiment of the present disclosure. For the purpose of discussion, the process 700 will be described with reference to FIG. 1. The process 700 may involve the terminal device 101 and the TRP 111 and 112 as illustrated in FIG. 1. It would be appreciated that although the process 700 has been described in the communication system 100 of FIG. 1, this process may be likewise applied to other communication scenarios where different network devices are jointly deployed to provide respective serving cells. It would also be appreciated that although the operation of TAs between the terminal device 101 and the TRP 111 and 112 is discussed, a similar process can be applied for any other terminal devices or network devices.

In the process 700, the terminal device 101 is operating using a first TA corresponding to the TRP 111 and a second TA corresponding to the TRP 112. The terminal device 101 obtains 710 a threshold configured by the network device. Additionally, the terminal device 101 may also obtain a report of a capability of the terminal device 101 supporting a number of TAs to the network. This report may be received via a message separate from the threshold configuration. The terminal device 101 receives 702 a first downlink reference signal which is corresponding to TRP 111. The terminal device 101 receives 704 a second downlink reference signal which is corresponding to the TRP 112. The terminal devices 101 obtains a time difference between the first downlink reference signal and the second downlink reference signal and determines 712 a status of a time difference relative to a threshold In responsive to a determination that the time difference is lower than or equal to or not higher than a threshold, or a number of times that the time difference being lower than or equal to or not higher than the threshold is beyond a predetermined number, or a duration of the time difference being lower than or equal to or not higher than the threshold is beyond a predetermined duration, the terminal device 101 triggers 714 an indication that indicates such status. The terminal device 101 transmits 706 the indication to the TRP 112. Based on the indication, the network decides 720 to deactivate for example the second TA corresponding to the TRP 112. The TPR 112 transmits 708 a configuration indicating the terminal device 101 to deactivate an operation of further using the second TA corresponding to the TRP 112.

It is noted that although FIG. 7 mentions about association of a TA loop to a TRP, this association may be indirect. For example, the association of TA loop may only be associated to a TAG and not to a TRP. As another example, a TA loop corresponds to a TAG and this TAG is associated to a TRP or CORESETPoolIndex (or PCI).

In some embodiments, an apparatus capable of performing any of the method 200 (for example, the terminal device 101) may comprise means for performing the respective steps of the method 200. The means may be implemented in any suitable form. For example, the means may be implemented in a circuitry or software module.

In some embodiments, the apparatus comprises means for obtaining a time difference between a first downlink reference signal and a second downlink reference signal; and means for transmitting an indication on status of the time difference relative to a threshold.

In some embodiments, the apparatus further comprises means for performing other steps in some embodiments of the method 200. In some embodiments, the means comprises at least one processor; and at least one memory including computer program code, the at least one memory and computer program code configured to, with the at least one processor, cause the performance of the apparatus. Or the means comprises at least one processor, and one or more transceiver which is coupled to the at least one processor, and cause the performance of the apparatus.

In some embodiments, an apparatus capable of performing any of the method 300 (for example, the terminal device 101) may comprise means for performing the respective steps of the method 300. The means may be implemented in any suitable form. For example, the means may be implemented in a circuitry or software module.

In some embodiments, the apparatus comprises means for receiving a configuration to activate or deactivate using of a Timing Advance, TA, wherein the configuration is based on an indication or uplink transmissions; and means for activating or deactivating using of the TA based on the configuration.

In some embodiments, the apparatus further comprises means for performing other steps in some embodiments of the method 300. In some embodiments, the means comprises at least one processor; and at least one memory including computer program code, the at least one memory and computer program code configured to, with the at least one processor, cause the performance of the apparatus.

In some embodiments, an apparatus capable of performing any of the method 400 (for example, the TRP 111 and/or 112) may comprise means for performing the respective steps of the method 400. The means may be implemented in any suitable form. For example, the means may be implemented in a circuitry or software module.

In some embodiments, the apparatus comprises: means for receiving an indication on status of a time difference between a first downlink reference signal and a second downlink reference signal relative to a threshold; and means for transmitting a configuration to activate or deactivate using of a timing advance, TA.

In some embodiments, the apparatus further comprises means for performing other steps in some embodiments of the method 400. In some embodiments, the means comprises at least one processor; and at least one memory including computer program code, the at least one memory and computer program code configured to, with the at least one processor, cause the performance of the apparatus. Or the means comprises at least one processor, and one or more transceiver which is coupled to the at least one processor, and cause the performance of the apparatus.

In some embodiments, an apparatus capable of performing any of the method 500 (for example, the TRP 111 and/or 112) may comprise means for performing the respective steps of the method 500. The means may be implemented in any suitable form. For example, the means may be implemented in a circuitry or software module.

In some embodiments, the apparatus comprises: means for determining a configuration to activate or deactivate using of a timing advance, TA, based on an indication or uplink transmissions; and means for transmitting a configuration to activate or deactivate using of a timing advance, TA; and means for transmitting the configuration to activate or deactivate using of the TA.

In some embodiments, the apparatus further comprises means for performing other steps in some embodiments of the method 500. In some embodiments, the means comprises at least one processor; and at least one memory including computer program code, the at least one memory and computer program code configured to, with the at least one processor, cause the performance of the apparatus. Or the means comprises at least one processor, and one or more transceiver which is coupled to the at least one processor, and cause the performance of the apparatus.

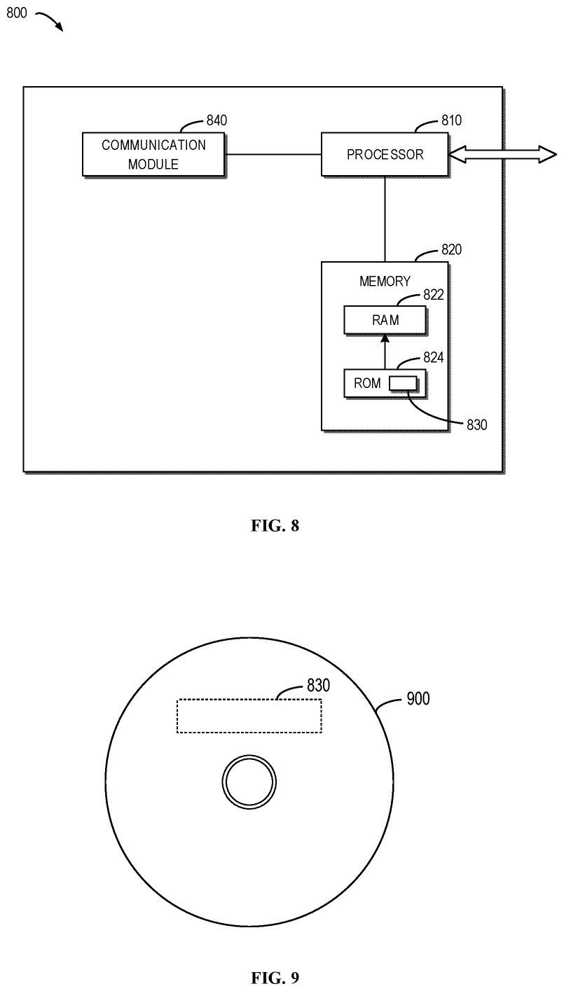

Reference is made to FIG. 8, which illustrates a simplified block diagram of a device 800 that is suitable for implementing some example embodiments of the present disclosure. The device 800 may be provided to implement a communication device, for example, the terminal device 101, and the TRP 111 and 112 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network elements.

The communication module 840 may include for example one or more transceivers. The one or more transceivers may be coupled with one or more antennas, to wirelessly transmit and receive communication signals. The one or more transceivers allow the communication device to communicate with other devices that may be wired and/or wireless. The transceiver may support one or more radio technologies. For example, the one or more transceivers may include a cellular subsystem, a WLAN subsystem, and/or a Bluetooth™ subsystem. In some examples, the one or more transceivers may include processors, controllers, radios, sockets, plugs, buffers, and like circuits/devices used for connecting to and communication on networks.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 2 to 7. The embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like.

Reference is made to FIG. 9, which illustrates a block diagram of an example of a computer readable medium 900 in accordance with some example embodiments of the present disclosure. The computer readable medium 900 has the program 830 stored thereon. It is noted that although the computer readable medium 900 is depicted in form of CD or DVD in FIG. 9, the computer readable medium 900 may be in any other form suitable for carry or hold the program 830.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 200, 300, 400 or 500 as described above with reference to FIG. 2, 3, 4 or 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-31. (canceled)

32. A terminal device, comprising:
at least one processor; and
at least one memory storing instructions that, when executed by the at least one processor, cause the terminal device at least to:
obtain, by the terminal device, a time difference between a first downlink reference signal and a second downlink reference signal; and
transmit, by the terminal device, an indication on status of the time difference relative to a threshold.

33. The terminal device of claim 32, wherein the first downlink reference signal is corresponding to a first Transmission Reception Point, TRP, and the second downlink reference signal is corresponding to a second TRP.

34. The terminal device of claim 32, wherein the indication is triggered when:
the time difference is higher than or equal to a threshold; or
a number of times that the time difference being higher than or equal to the threshold is beyond a predetermined number; or
a duration of the time difference being higher than or equal to the threshold is beyond a predetermined duration.

35. The terminal device of claim 32, wherein the indication is triggered when:
the time difference is lower than a threshold; or
a number of times that the time difference being lower than the threshold is beyond a predetermined number; or
a duration of the time difference being lower than the threshold is beyond a predetermined duration.

36. The terminal device of claim 32, wherein the terminal device is operating using a first timing advance, TA, corresponding to a first TRP, and the indication indicates a status regarding the time difference being higher than or equal to the threshold or a status regarding the time difference being higher than the threshold.

37. The terminal device of claim 36, wherein the terminal device is further caused to:
receive, by the terminal device, a configuration indicating the terminal device to activate an operation of further using a second TA associated with the second TRP.

38. The terminal device of claim 32, wherein the terminal device is operating using a first TA corresponding to a first TRP and a second TA corresponding to a second TRP, and the indication indicates a status regarding the time difference being lower than the threshold or a status regarding the time difference being lower than or equal to the threshold.

39. The terminal device of claim 38, wherein the terminal device is further caused to:
receive, by the terminal device, a configuration indicating the terminal device to deactivate an operation of using the first TA or the second TA, or indicating the first TA or the second TA is used for both the first TRP and the second TRP.

40. The terminal device of claim 38, wherein the first TA is associated with a first TA Group, TAG, or associated with the first TRP corresponding to the first TAG, and
wherein the second TA is associated with a second TAG, or associated with the second TRP corresponding to the second TAG.

41. The terminal device of claim 32, wherein the terminal device is further caused to:
receive, by the terminal device, a threshold configuration, wherein the threshold configuration indicates the threshold.

42. The terminal device of claim 39, wherein deactivating the operation of using the first TA or the second TA comprises stopping maintaining the first TA or the second TA.

43. The terminal device of claim 32, wherein the indication is carried in Uplink Control Information, UCI, or Medium Access Control Control Element, MAC CE.

44. The terminal device of claim 37, wherein the configuration is carried by Downlink Control Information, DCI, MAC CE, Radio Resource Control, or RRC, signaling.

45. The terminal device of claim 37, wherein a TRP which the configuration is for is determined based on the Control Resource Set, CORESET in which the configuration is transmitted.

46. The terminal device of claim 32, wherein both intra-cell multi-TRP and inter-cell multi-TRP are configured, and wherein obtaining the time difference comprises obtaining a time difference for the intra-cell multi-TRP and one or more time differences for the inter-cell multi-TRP.

47. The terminal device of claim 32, wherein both intra-cell multi-TRP and inter-cell multi-TRP are configured, and wherein the terminal device is further caused to:
report, by the terminal device, a capability of the terminal device supporting a number of TAs.

48. A network device, comprising:
at least one processor; and
at least one memory storing instructions that, when executed by the at least one processor, cause the network device at least to:
receive, by the network device, an indication on status of a time difference between a first downlink reference signal and a second downlink reference signal relative to a threshold; and
transmit, by the network device, a configuration to activate or deactivate using of a timing advance, TA.

49. The network device of claim 48, wherein the indication indicates a status regarding the time difference being higher than or equal to the threshold, or a status regarding the time difference being higher than the threshold.

50. The network device of claim 48, wherein the indication indicates a status regarding the time difference being lower than the threshold, or a status regarding the time difference being lower than or equal to the threshold.

51. A method at a terminal device, comprising:
obtaining, by the terminal device, a time difference between a first downlink reference signal and a second downlink reference signal; and
transmitting, by the terminal device, an indication on status of the time difference relative to a threshold.
